(19) United States
(12) Patent Application Publication
(10) Pub. No.: US 2024/0142048 A1
(43) Pub. Date: May 2, 2024

(54) ELECTRIC TELEVISION BRACKET

(71) Applicant: DewertOkin Technology Group Co., Ltd., Jiaxing (CN)

(72) Inventors: DELIANG DUANMU, Jiaxing (CN); CHENG CHEN, Jiaxing (CN); GUOQIANG YAN, Jiaxing (CN)

(21) Appl. No.: 18/380,546

(22) Filed: Oct. 16, 2023

(30) Foreign Application Priority Data
Nov. 1, 2022 (CN) 202222894641.9

(51) Int. Cl. F16M 13/02

(52) U.S. Cl. CPC F16M 13/02; F16M 2200/06

(57) ABSTRACT

The present disclosure provides an electric television bracket, which includes a fix seat; an installation rack, configured to install a television; a connector, where one end thereof is fixed to the fix seat and the other end thereof is connected to the installation rack through a first pivot; a connection mechanism, where one end thereof is connected to the installation rack through a second pivot and the other end thereof is connected to the fix seat through a third pivot; and a drive unit, where a first end thereof is rotatably connected to the installation rack and a second end thereof is rotatably connected to the fix seat; and a distance between the first pivot and the second pivot is at least one-third of a length of the installation rack.

### CROSS-REFERENCE TO RELATED APPLICATIONS

This application claims priorities to Chinese Patent Application No. 202222894641.9, filed on Nov. 1, 2022, and Chinese Patent Application No. 202222510055.X, filed on Sep. 22, 2022, both of which are hereby incorporated by reference in their entireties.

### TECHNICAL FIELD

The present disclosure relates to an electric television bracket.

### BACKGROUND

At present, the main electric brackets for ceiling mounted televisions in the market mainly use a driver to drive the rotation of the brackets. To achieve an expansion and closure functions of the television, the principle is a combination of sliding and rotation of a mechanism to achieve the function of the device. It has the following defects: complex assembly, high cost, unsmooth sliding, and large noise caused by sliding, heavy overall weight, etc.

Chinese utility model patent CN217208802U, announcement on Aug. 16, 2022, discloses an electric bracket for a ceiling television, which includes a fix seat (1), a rack body (2), two first connectors (3), two second connectors (4), and two third connectors (5). One ends of the two first connectors (3) and one ends of the two second connectors (4) are symmetrically hinged on both sides of the rack body (2), the other ends of the two first connectors (3) are respectively hinged on both sides of one end of the fix seat (1) in a width direction of the fix seat (1), one ends of the two third connectors are hinged on a middle of the two second connectors (4), and the other ends of the two third connectors (5) are respectively hinged on both sides of the fix seat (1) in the width direction. The electric bracket is characterized in that the other end of the fix seat (1) is equipped with a connection pivot (6) that can slide along its length direction, the other ends of the two second connectors (4) are respectively hinged at both ends of the connection pivot (6), and the fix seat (1) is equipped with a drive component for driving the connection pivot (6) to move back and forth along a length direction of the fix seat (1) to drive the rack body (2) to be in an folded or unfolded state with the fix seat (1). The fix seat (1) is further equipped with a control box (17) for controlling a movement of the drive component. The connection pivot (6) of the television bracket is arranged in a sliding groove (1.1) on the fix seat (1), and a drive motor (8) drives the connection pivot (6) to slide in the sliding groove, thereby driving a connection mechanism to move. The electric bracket for a ceiling television is a typical above-mentioned television bracket, and has multiple above-mentioned drawbacks. For example, when the connection pivot (6) slides inside the sliding groove (1.1), there may be a problem of unsmooth sliding, and a noise may be generated due to a friction between the two during a sliding process.

CN105003806A, published on Oct. 28, 2015, discloses a top mounted television bracket, which has the same basic operating structure as the above-mentioned electric bracket for a ceiling television, and also has technical problems existing in the existing technology of television brackets.

### SUMMARY

The purpose of the present disclosure is to overcome the above-mentioned defects in existing technology and provide an electric television bracket with a reasonable structural design.

The technical solution adopted by an embodiment of the present disclosure to solve the above problems is: an electric television bracket, including:
a fix seat;
an installation rack, configured to install a television;
a connector, where one end thereof is fixed to the fix seat and the other end thereof is connected to the installation rack through a first pivot;
a connection mechanism, where one end thereof is connected to the installation rack through a second pivot and the other end thereof is connected to the fix seat through a third pivot; and
a drive unit, where a first end thereof is rotatably connected to the installation rack and a second end thereof is rotatably connected to the fix seat; and a distance between the first pivot and the second pivot is at least one-third of a length of the installation rack.

In an embodiment of the present disclosure, the distance between the first pivot and the second pivot is at least two fifths of the length of the installation rack.

In an embodiment of the present disclosure, a distance from the third pivot to a connection position of the connector and the fix seat is at least one-third of a length of the fix seat, and does not exceed a half of the length of the fix seat.

In an embodiment of the present disclosure, the connection mechanism includes a first connection rod and a second connection rod, where a first end of the first connection rod is rotatably connected to the fix seat, a first end of the second connection rod is rotatably connected to the installation rack, and a second end of the first connection rod and a second end of the second connection rod are respectively rotatably connected to a fourth pivot.

In an embodiment of the present disclosure, the fix seat includes a flat base and a shell provided on the base, where the shell has an opening communicating an internal space of the shell.

In an embodiment of the present disclosure, there are a folded state and an unfolded state between the fix seat and the installation rack due to a change of their relative positions, and at least a part of the drive unit enters an interior of the shell through the opening when in the folded state and/or unfolded state.

In an embodiment of the present disclosure, there are a folded state and an unfolded state between the fix seat and the installation rack due to a change of their relative positions, and the connection mechanism is located within a range limited by the fix seat in a length direction when in the folded state and/or unfolded state.

In an embodiment of the present disclosure, the drive unit is located within a space defined by a top of the fix seat and a bottom of the installation rack when in the folded state.

In an embodiment of the present disclosure, the drive unit includes a telescopic mechanism, the telescopic mechanism drives the installation rack through a change of a length of the telescopic mechanism to achieve an angle adjustment between the fix seat and the installation rack.

In an embodiment of the present disclosure, the installation rack includes a support rack and a hang plate provided on the support rack, and the hang plate is provided with one or more installation holes.
the installation rack further includes a positioning unit including a stop part and a fastener, the stop part is slidably provided on the support rack and fixed by the fastener, the hang plate is limited by the stop part in a width direction of the support rack.

An embodiment of the present disclosure further provides an electric television bracket, including:
a fix seat;
an installation rack, configured to install a television;
a connector, where one end thereof is fixed to the fix seat and the other end thereof is rotatably connected to the installation rack;
a connection mechanism, where one end thereof is rotatably connected to the installation rack and the other end thereof is rotatably connected to the fix seat; and
a drive unit, where a first end thereof is rotatably connected to the connection mechanism and a second end thereof is rotatably connected to the fix seat; an angle adjustment between the fix seat and the installation rack is achieved through an action of the connection mechanism;
where, the connection mechanism further includes a pivot, and a first end of the drive unit is rotatably connected to the pivot;
where, the connection mechanism includes a first connection rod and a second connection rod, where a first end of the first connection rod is rotatably connected to the fix seat, a first end of the second connection rod is rotatably connected to the installation rack, and a second end of the first connection rod and a second end of the second connection rod are respectively rotatably connected to the pivot.

In an embodiment of the present disclosure, the fix seat includes a flat base and a shell provided on the base, where the shell has an opening communicating an internal space of the shell.

In an embodiment of the present disclosure, there are a folded state and an unfolded state between the fix seat and the installation rack due to a change of their relative positions, and at least a part of the drive unit enters an interior of the shell through the opening when in the folded state and/or unfolded state.

In an embodiment of the present disclosure, the drive unit is located within a space defined by a top of the fix seat and a bottom of the installation rack when in the folded state.

In an embodiment of the present disclosure, the drive unit includes a telescopic mechanism, the telescopic mechanism drives the connection mechanism through a change of a length of the telescopic mechanism to achieve an angle adjustment between the fix seat and the installation rack.

In an embodiment of the present disclosure, the shell further includes a fix box placing a power supply of the drive unit.

In an embodiment of the present disclosure, at least 80% of an area of the fix box is within a range defined by the shell in a projection direction of a width direction of the shell.

In an embodiment of the present disclosure, the installation rack includes a support rack and a hang plate provided on the support rack, and the hang plate is provided with one or more installation holes;
the installation rack further includes a positioning unit including a stop part and a fastener, the stop part is slidably installed on the support rack and fixed by the fastener, the hang plate is limited by the stop part in a width direction of the support rack.

Compared with the existing technology, the present disclosure has one or more advantages or effects as follows: simple structure, reasonable design; due to the fact that the pivot does not need to be sliding connected to the fix seat, there is no friction between the two, a noise during operation is small; by adjusting the connection mechanism, the operation is smoother and a stability during operation is better; by directly driving the installation rack through the drive unit for adjustment, its operation is smoother, the stability during operation is better, and an energy loss during movement is reduced, which can increase thrust and prevent shaking; a distance between the first pivot and the second pivot is at least one-third of a length of the installation rack. The first pivot and the second pivot are two fulcrums in the length direction of the installation rack. When the distance between these two fulcrums meets the above relationship, it can provide a good support for the installation rack to improve its stability during a movement and prevent significant shaking caused by a television installed on the installation rack being too heavy.

### BRIEF DESCRIPTION OF DRAWINGS

In order to provide a clearer explanation of an embodiment of the present disclosure or the technical solution in the prior art, a brief introduction will be given to the drawings required in the embodiment or the description of the prior art. It is evident that the drawings in the following description are only some embodiments of the present disclosure. For ordinary technical personnel in this field, other drawings can be obtained based on these drawings without any creative work.

FIG. 1 is a schematic diagram of a side view of an electric television bracket in Embodiment 1 of the present disclosure, showing an unfolded state.

FIG. 2 is a first schematic diagram of a perspective view of the electric television bracket in Embodiment 1 of the present disclosure, showing the unfolded state.

FIG. 3 is a second schematic diagram of the perspective view of the electric television bracket in Embodiment 1 of the present disclosure, showing the unfolded state.

FIG. 4 is an enlarged view of A in FIG. 3.

FIG. 5 is a third schematic diagram of the perspective view of the electric television bracket in Embodiment 1 of the present disclosure, showing the unfolded state.

FIG. 6 is a schematic diagram of a side view of the electric television bracket in Embodiment 1 of the present disclosure, showing a folded state.

FIG. 7 is a first schematic diagram of a perspective view of the electric television bracket in Embodiment 2 of the present disclosure, showing the unfolded state.

FIG. 8 is a second schematic diagram of the perspective view of the electric television bracket in Embodiment 2 of the present disclosure, showing the unfolded state.

FIG. 9 is a third schematic diagram of the perspective view of the electric television bracket in Embodiment 2 of the present disclosure, showing the unfolded state.

FIG. 10 is a fourth schematic diagram of the perspective view of the electric television bracket in Embodiment 2 of the present disclosure, showing the unfolded state.

FIG. 11 is an enlarged view of A in FIG. 10.

FIG. 12 is a schematic diagram of a side view of the electric television bracket in an embodiment of the present disclosure, showing a folded state.

### REFERENCE NUMBER

1. Fix seat; 11. Base; 12. Shell; 2. Installation rack; 21. Support rack; 211. Sliding groove; 22. Hang plate; 221. Installation hole; 23. Positioning unit; 231. Stop part; 232. Fastener; 3. Connector; 4. Connection mechanism; 41. First connection rod; 42. Second connection rod; 5. Pivot; 6. Drive unit; 7. First pivot; 8. Second pivot; 9. Third pivot; 1a. Fix seat; 11a. Base; 12a. Shell; 121a. Fix box; 2a. Installation rack; 21a. Support rack; 211a, Sliding groove; 22a. Hang plate; 221a. Installation hole; 23a. Positioning unit; 231a. Stop part; 232a. Fastener; 3a. Connector, 4a. Connection mechanism; 41a. First connection rod; 42a, Second connection rod; 5a. Pivot; 6a. Drive unit.

### DETAILED DESCRIPTION

In order to facilitate an understanding of the present disclosure, a more comprehensive description of the present disclosure will be provided below with reference to the relevant drawings. The drawings provide some embodiment of the present disclosure. However, the present disclosure can be implemented in many different forms, not limited to the embodiment described below. On the contrary, a purpose of providing these embodiments is to provide a more thorough and comprehensive understanding of the disclosed content of the present disclosure. A direction mentioned in the following description, such as “axial direction”, “up”, “below”, are all for a purpose of clearly indicating a structural position relationship, and are not a limitation on the present disclosure. In the present disclosure, the definitions of “vertical”, “horizontal”, and “parallel” are: including ±10% b of a situation based on a standard definition. For example, vertical usually refers to an angle of 90 degrees relative to a reference line, but in the present disclosure, vertical refers to a situation ranging from 80 degrees to 100 degrees.

### Embodiment 1

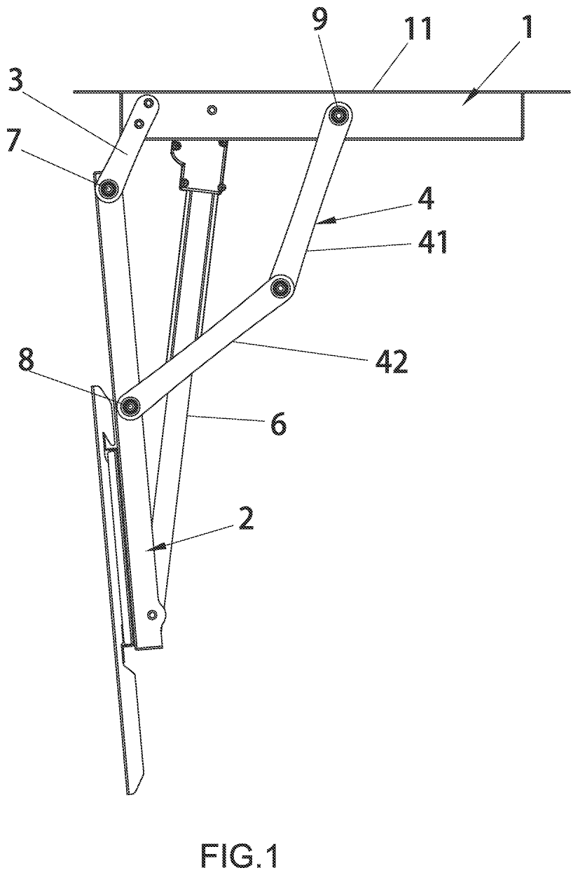

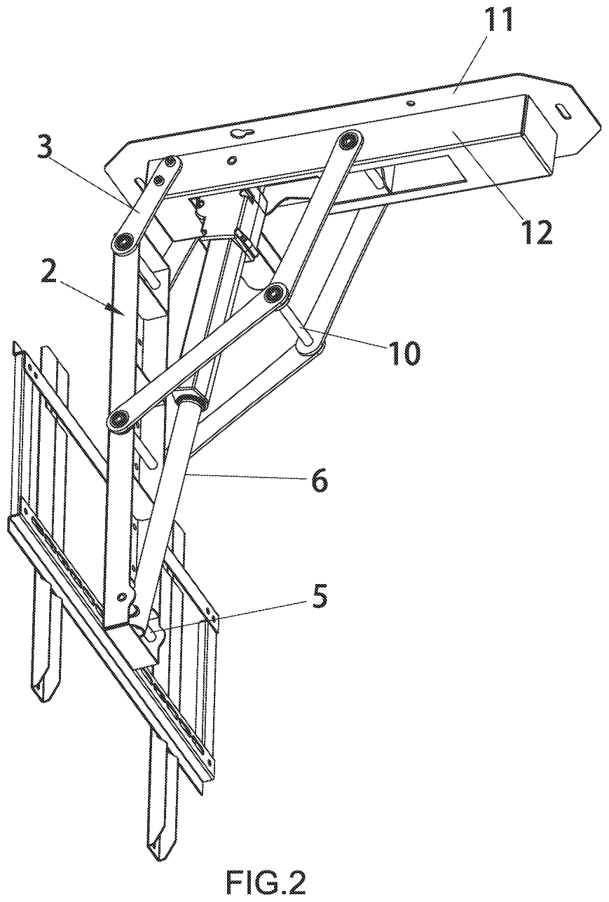

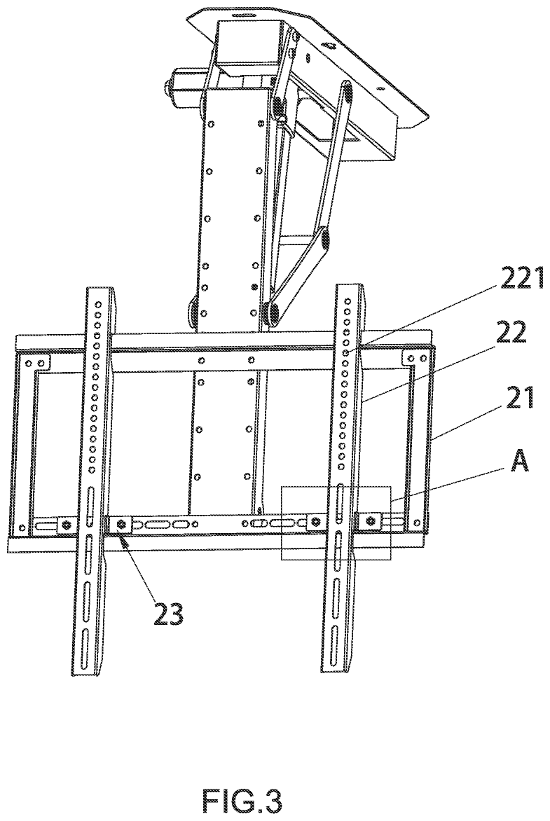

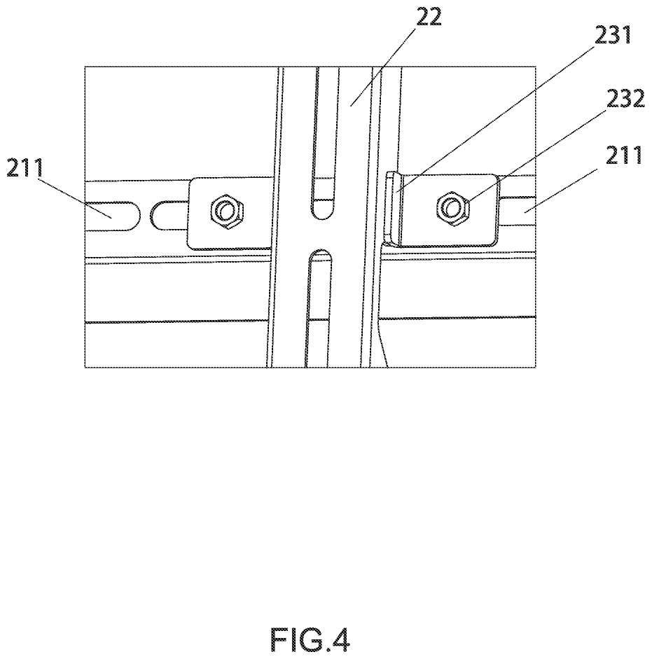

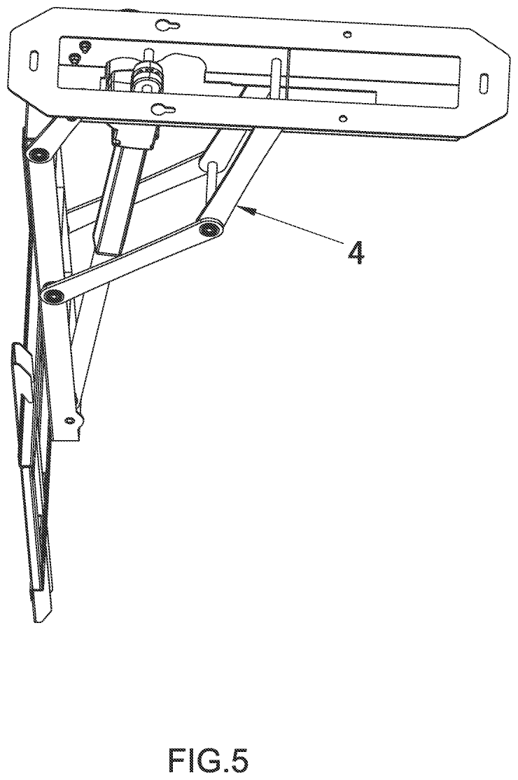

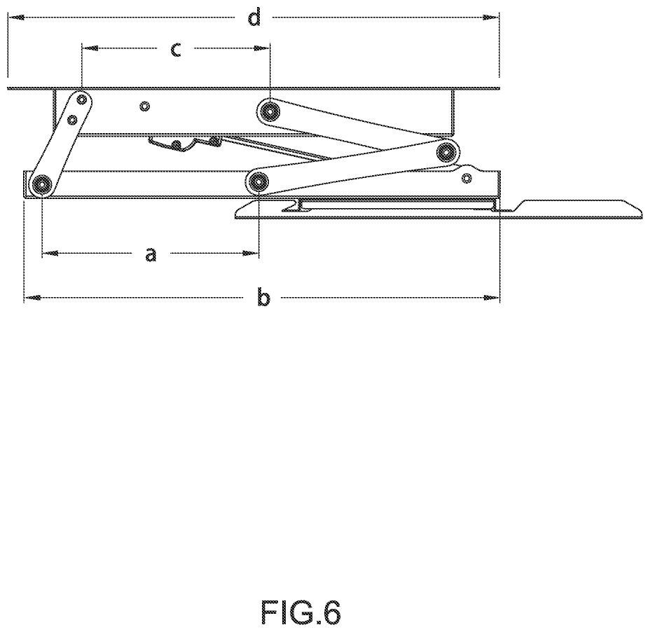

Referring to FIGS. 1 to 6, an electric television bracket of this embodiment includes a fix seat 1, an installation rack 2, a connector 3, a connection mechanism 4, and a drive unit 6.

The fix seat 1 in this embodiment is configured to be installed on a flat surface such as a ceiling. A hole can be provided on the fix seat 1 to install the fix seat onto a surface, such as a ceiling, through a fastener.

The installation rack 2 in this embodiment is configured to install a television. The installation rack 2 is connected to the fix seat 1 through the connector 3. Specifically, one end of the connector 3 is fixed to the fix seat 1, and the other end of the connector 3 is connected to the installation rack 2 through a first pivot 7, so that the connector 3 can rotate relative to the installation rack 2. By connecting the fix seat 1 and the installation rack 2 through the connector 3, the fix seat 1 and the installation rack 2 can be rotated to a position parallel or roughly parallel to each other, providing a foundation for folding and unfolding the electric television bracket. And, when the fix seat 1 is parallel or roughly parallel to the installation rack 2, a distance can be maintained between the fix seat 1 and the installation rack 2 to prevent an interference between the two.

A first end of the drive unit 6 in this embodiment is rotatably connected to the installation rack 2 and a second end of the drive unit 6 is rotatably connected to the fix seat 1. Furthermore, the drive unit 6 is rotatably connected to the pivot 5 provided on the installation rack, so that the drive unit 6 can adjust a state of the installation rack 2 by controlling a position of the pivot 5, thereby adjusting an angle between the fix seat 1 and the installation rack 2. The above electric television bracket has a simple structure and a reasonable design. Due to the fact that pivot 5 does not need to be sliding connected to fix seat 1, there is no friction between the two, a noise during operation is small; by directly driving the installation rack 2 through the drive unit 4 for adjustment, its operation is smoother, a stability during operation is better, and an energy loss during moving is reduced, which can increase thrust and prevent shaking.

A distance (a) between the first pivot 7 and the second pivot 8 in this embodiment is at least one-third of a length (b) of the installation rack 2. The first pivot 7 and the second pivot 8 are two fulcrums in the length direction of the installation rack 2. When the distance between these two fulcrums meets the above relationship, they can provide a good support for the installation rack 2, improve its stability during moving and prevent significant shaking caused by the television installed on the installation rack 2 being too heavy.

In an implementation mode, the distance (a) between the first pivot 7 and the second pivot 8 is at least two fifths of the length (b) of the installation rack 2.

In this embodiment, a distance (c) from the third pivot 9 to a connection point of the connector 3 and the fix seat 1 is at least one-third of a length (d) of the fix seat, and does not exceed a half of the length (d) of the fix seat. Combined with a position of the second pivot 8, the above setting can control an overall length of the connection mechanism 4.

In this embodiment, one end of the connection mechanism 4 is connected to the installation rack 2 through the second pivot 8 and the other end thereof is connected to the fix seat 1 through a third pivot 9. Furthermore, the connection mechanism 4 in this embodiment further includes a fourth pivot 10, which is arranged at a joint of the connection mechanism 4 and forms a hinge pivot of the connection mechanism 4.

The connection mechanism 4 in this embodiment includes a first connection rod 41 and a second connection rod 42, where a first end of the first connection rod 41 is rotatably connected to the fix seat 1, a first end of the second connection rod 42 is rotatably connected to the installation rack 2, and a second end of the first connection rod 41 and a second end of the second connection rod 42 are respectively rotatably connected to the fourth pivot 10. The first connection rod 41, the second connection rod 42, the fix seat 1, the installation rack 2, and the connector 3 form a connection rod structural mechanism. The setting of connection mechanism 4 can improve the stability when the electric television bracket is in operation.

The fix seat 1 in this embodiment includes a flat base 11 and a shell 12 provided on the base 11, the shell 12 has an opening communicating an internal space of the shell. The flat base 11 can be attached to the ceiling for installation. And an installation hole can be provided on the base 11 for a fastener to pass through and attach the base 11 to the ceiling.

In this embodiment, there are a folded state and an unfolded state between the fix seat and the installation rack due to a change of their relative positions. In the folded state and/or unfolded state, at least a part of the drive unit 6 enters an inner of the shell 12 through the opening. Therefore, a space utilization of the electric television bracket is good, and its overall size can be controlled.

In this embodiment, and in the folded state and/or unfolded state, the connection mechanism 12 4 is located within a range limited by the fix seat 1 in its length direction.

In the folded state, the fix seat 1 is set parallel or roughly parallel to the installation rack 2. In the unfolded state, an angle between the fix seat 1 and the installation rack 2 does not exceed 100 degrees, while in the unfolded state, it is a state at which the fix seat 1 and the installation rack 2 can be unfolded at a maximum angle. That is to say, the angle between the fix seat 1 and the installation rack 2 can be adjusted arbitrarily between 0 degree and 100 degrees.

In this embodiment, when in the folded state, the drive unit 6 is located in a space defined by a top of the fix seat 1 a bottom of the installation rack 2. Therefore, if the folded state is used as a packaging form, a packaging size can be controlled for easy transportation, and when in use, the drive unit 6 is visually not exposed, which can improve aesthetics.

The drive unit 6 in this embodiment includes a telescopic mechanism, which drives the installation rack 2 through a change of its length to achieve an angle adjustment between the fix seat 1 and the installation rack 2. The telescopic mechanism can be achieved through an existing technology such as a screw structure or a cylinder structure, and will not be elaborated here.

The installation rack2 in this embodiment includes a support rack 21 and a hang plate 22 provided on the support rack21, and the hang plate 22 is provided with one or more installation holes 221. The hang plate 22 can slide after being hung on the support rack 21 to adjust a position of the television.

Several holes are provided on the installation rack 2 for fixing the support rack21 through a bolt. A height of the support rack 21 can be adjusted through different installation hole positions.

The electric television bracket in this embodiment further includes a positioning unit 23 including a stop part 231 and a fastener 232. The stop part 231 is slidably installed on the support rack 21 and fixed by the fastener 232. The hang plate 22 is limited by the stop part 231 in a width direction of the support rack 21. When the hang plate 22 slides to a desired position on the support rack 21, it can be positioned through the positioning unit 23 to limit its position; thereby improving a reliability when the hang plate 22 is cooperation with the support rack 21.

In this embodiment, the fastener 232 includes a bolt and a nut, the bolt passes through the stop part 231 and the sliding groove 211 on the support rack 21, and enables the stop part 231 to slide along the sliding groove 211. When sliding to a desired position, positions of the stop portion 231 and the support rack 21 are fixed by a locking of the bolt and nut. The sliding groove 211 211 can be one or more elongated circular holes.

A group of positioning units 23 are provided on both sides a group of hang plates 22 in a width direction thereof to limit the hang plates 22 to slide towards both sides.

A working principle of the electric television bracket in this embodiment is as follows: a driver (namely, the drive unit 6) performs a telescopic motion, and the drive unit 6 drives the pivot 5 to move. The pivot 5 rotates around a hinge pivot of the first connection rod 41 and the fix seat 1 under a constraint of the first connection rod 41, and this motion is transmitted to a hinge pivot of the second connection rod 42 and the installation rack 2 through the second connection rod 42. The installation rack 2 rotates around a hinge pivot of the connector 3 and the fix seat 1 under a drive of the second connection rod 42; thus, a round-trip rotation movement of the installation rack is achieved.

### Embodiment 2

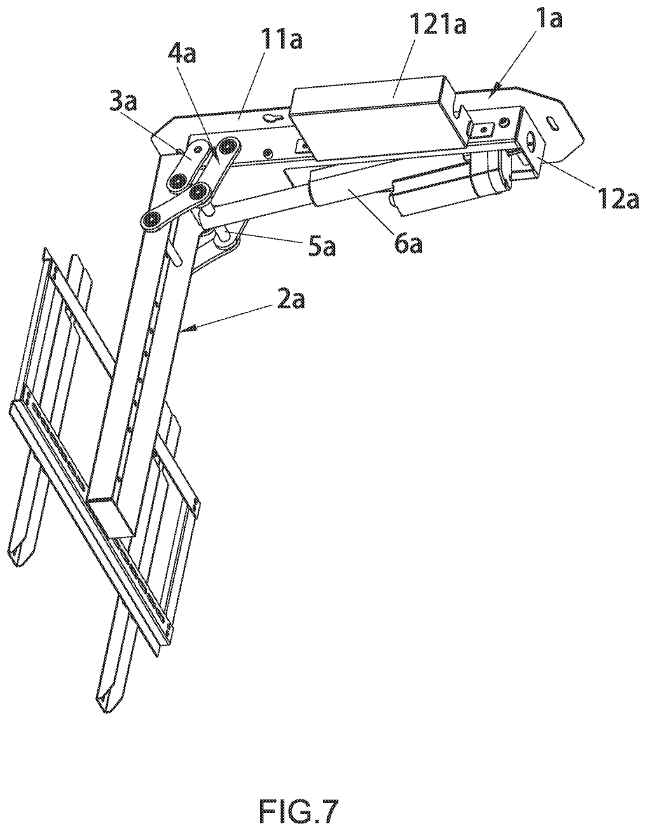

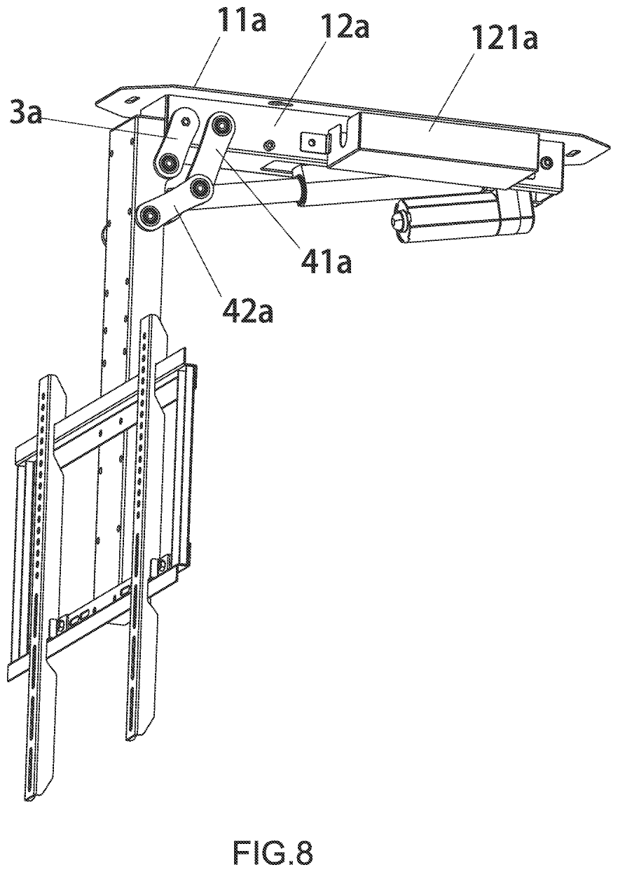

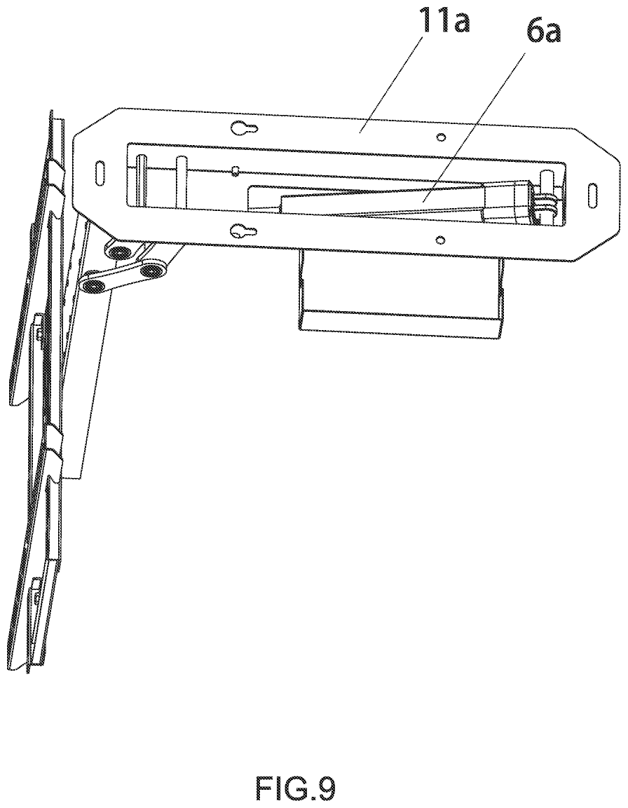

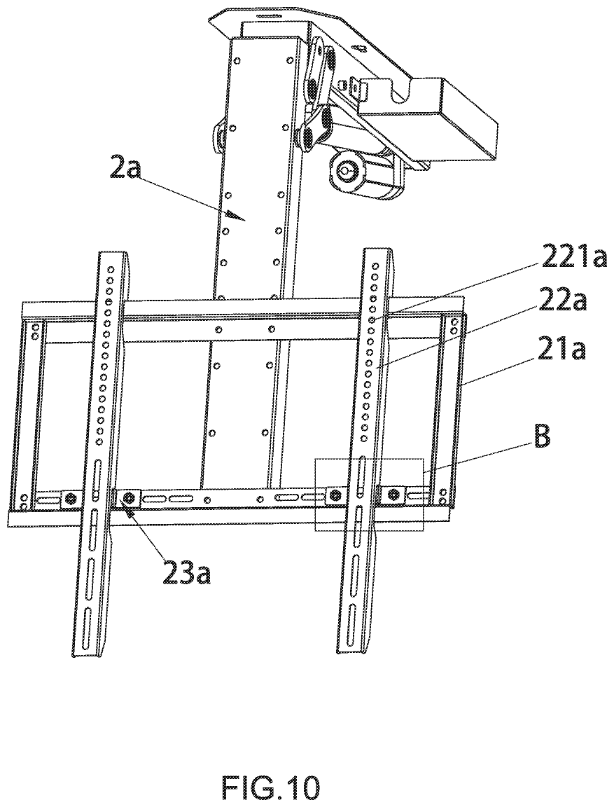

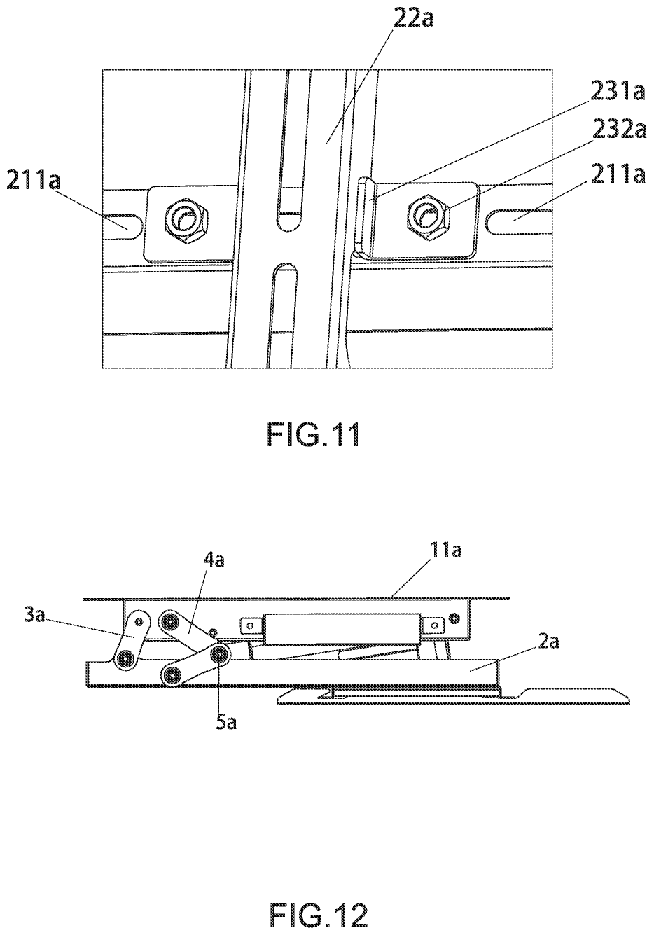

Referring to FIGS. 7 to 12, an electric television bracket of this embodiment includes a fix seat 1a, an installation rack 2a, a connector 3a, a connection mechanism 4a, and a drive unit 6a.

The fix seat 1a in this embodiment is configured to be installed on a flat surface such as a ceiling. A hole can be provided on the fix seat 1a to install the fix seat onto a surface such as a ceiling through a fastener.

The installation rack 2a in this embodiment is configured to install a television. The installation rack 2a is connected to the fix seat 1a through the connector 3a. Specifically, one end of the connector 3a is connected (fixed) to the fix seat 1a and the other end thereof is rotatably connected to the installation rack 2a. By connecting the fix seat 1a and the installation rack 2a through the connector 3a, the fix seat 1a and the installation rack 2a can be rotated to a position parallel or roughly parallel to each other, providing a foundation for folding and unfolding the electric television bracket. And when the fix seat 1a is parallel or roughly parallel to the installation rack 2a, a distance can be maintained between the fix seat 1a and the installation rack 2a to prevent an interference between the two.

In this embodiment, an end of the connection mechanism 4a is rotatably connected to the installation rack 2a and the other end thereof is rotatably connected to the fix seat 1a. Furthermore, the connection mechanism 4a in this embodiment further includes a pivot 5a, which is arranged at a joint of the connection mechanism 4a and forms a hinge of the connection mechanism 4a.

In this embodiment, a first end of the drive unit 6a is rotatably connected to the connection mechanism 4a (specifically, the first end of the drive unit 6a is rotatably connected to a pivot 5a of the connection mechanism 4a), and a second end thereof is rotatably connected to the fix seat 1a. The drive unit 6a can adjust the connection mechanism 4a by controlling a position of the pivot 5a, so as to adjust an angle between the fix seat 1a and the installation rack 2a. That is to say, the angle adjustment between the fix seat 1a and the installation rack 2a is achieved through an action of the connection mechanism 4a. The above electric television bracket has a simple structure and a reasonable design; due to the fact that the pivot 5a does not need to be sliding connected to the fix seat 1a, there is no friction between the two, and a noise during operation is relatively low; by adjusting the connection mechanism 4a, the operation is smoother and a stability during operation is better.

The connection mechanism 4a in this embodiment includes a first connection rod 41a and a second connection rod 42a, and a first end of the first connection rod 41a is rotatably connected to the fix seat 1a, a first end of the second connection rod 42a is rotatably connected to the installation rack 2a, a second end of the first connection rod 41a and a second end of the second connection rod 42a are respectively rotatably connected to the pivot 5a. The first connection rod 41a, the second connection rod 42a, the fix seat 1a, the installation rack 2a, and the connector 3a form a connection rod structure mechanism.

The fix seat 1a in this embodiment includes a flat base 11a and a shell 12a provided on the base 11a, the shell 12a has an opening communicating an internal space of the shell. The flat base 11a can be attached to the ceiling for installation. And installation holes can be provided on the base 11a for a fastener to pass through and attach the flat base to the ceiling.

In this embodiment, there are a folded state and an unfolded state between the fix seat and the installation rack due to a change of their relative positions. In the folded and/or unfolded state, at least a part of the drive unit 6a enters an interior of the shell 12a through the opening. Therefore, a space utilization of the electric television bracket is good, and its overall size can be controlled.

In the folded state, the fix seat 1a is set parallel or roughly parallel to the installation rack 2a. In the unfolded state, an angle between the fix seat 1a and the installation rack 2a does not exceed 100 degrees, while in the unfolded state, it is a state at which the fix seat 1a and the installation rack 2a can be unfolded at a maximum angle. That is to say, the angle between the fix seat 1a and the installation rack 2a can be adjusted arbitrarily between 0 degree and 100 degrees.

In this embodiment, when in the folded state, the drive unit 6a is located at a space defined by a top of the fix seat 1a and a bottom of the installation rack 2a. Therefore, if the folded state is used as a packaging form, a packaging size of the electric television bracket can be controlled for easy transportation, and when in use, the drive unit 6a is visually not exposed, which can improve aesthetics.

The drive unit 6a in this embodiment includes a telescopic mechanism, which drives the connection mechanism 4a through a change of its length to achieve an angle adjustment of the fix seat 1a and the installation rack 2a. The telescopic mechanism can be achieved through an existing technology such as a screw structure or a cylinder structure, and will not be elaborated here.

The shell 12a in this embodiment further includes a fix box 121a for placing a power supply of the drive unit 6a. The fix box 121a is provided on the outer side wall of the shell 12a to facilitate the placement and maintenance of the power supply.

At least 80% of an area of the fix box 121a is within a range defined by the shell 12a in a projection direction of a width direction of the shell 12a, and whether in the unfolded or folded state, in the projection direction of the width direction of the shell 12a, the fix box 121a does not overlap with the installation rack 2a to prevent an interference between the two.

The installation rack 2a in this embodiment includes a support rack 21a and a hang plate 22a provided on the support rack 21a, and the hang plate 22a is provided with one or more installation holes 221a. The hang plate 22a can slide after being hung on the support rack 21a to adjust a position of the television.

Several holes are provided on the installation rack 2a for fixing the support rack21a through a bolt. A height of the support rack 21a can be adjusted through different installation hole positions.

The electric television bracket in this embodiment further includes a positioning unit 23a including a stop part 231a and a fastener 232a. The stop part 231a is slidably installed on the support rack 21a and fixed by the fastener 232a. The hang plate 22a is limited by the stop part 231a in a width direction of the support rack 21a. When the hang plate 22a slides to a desired position on the support rack 21a, it can be positioned through the positioning unit 23a to limit its position, thus improving a reliability when the hang plate 22a is cooperation with the support rack 21a.

In this embodiment, the fastener 232a includes a bolt and a nut, the bolt passes through the stop part 231a and the sliding groove 211a on the support rack 21a, and enables the stop part 231a to slide along the sliding groove 211a. When sliding to a desired position, positions of the stop part 231a and the support rack 21a are fixed by a locking of the bolt and nut. The sliding groove 211a can be one or more elongated circular hole.

A group of positioning units 23a are provided on both sides of a group of hang plates 22a in a width direction thereof to limit the hang plates 22a to slide towards both sides.

A working principle of the electric television bracket in this embodiment is that a driver (namely, the drive unit 6a) performs a telescopic motion, and the drive unit 6a drives the pivot 5a to move. The pivot 5a rotates around a hinge pivot of the first connection rod 41a and the fix seat 1a under a constraint of the first connection rod 41a, and this motion is transmitted to a hinge pivot of the second connection rod 42a and the installation rack 2a through the second connection rod 42a. The installation rack 2a rotates around a hinge pivot of the connecting member 3a and the fix seat 1a under a drive of the second connection rod 42a; thus, a round-trip rotation movement of the installation rack is achieved.

The above description described in the present disclosure is only an example of the present disclosure. Technicians in the technical field of the present disclosure may make various modifications or supplements to a specific embodiment described or use a similar method to substitute them. As long as they do not deviate from the description of the present disclosure or exceed the scope of the claims, they shall fall within the protection scope of the present disclosure.

What is claimed is:

1. An electric television bracket, comprising:
a fix seat;
an installation rack, configured to install a television;
a connector, wherein one end thereof is fixed to the fix seat and the other end thereof is connected to the installation rack through a first pivot;
a connection mechanism, wherein one end thereof is connected to the installation rack through a second pivot and the other end thereof is connected to the fix seat through a third pivot; and
a drive unit, wherein a first end thereof is rotatably connected to the installation rack and a second end thereof is rotatably connected to the fix seat; and a distance between the first pivot and the second pivot is at least one-third of a length of the installation rack.

2. The electric television bracket according to claim 1, wherein the distance between the first pivot and the second pivot is at least two fifths of the length of the installation rack.

3. The electric television bracket according to claim 1, wherein a distance from the third pivot to a connection point of the connector and the fix seat is at least one-third of a length of the fix seat, and does not exceed a half of the length of the fix seat.

4. The electric television bracket according to claim 1, wherein the connection mechanism comprises a first connection rod and a second connection rod, wherein a first end of the first connection rod is rotatably connected to the fix seat, a first end of the second connection rod is rotatably connected to the installation rack, and a second end of the first connection rod and a second end of the second connection rod are respectively rotatably connected to a fourth pivot.

5. The electric television bracket according to claim 1, wherein the fix seat comprises a flat base and a shell provided on the base, wherein the shell has an opening communicating an internal space of the shell.

6. The electric television bracket according to claim 5, wherein there are a folded state and an unfolded state between the fix seat and the installation rack due to a change of their relative positions, and at least a part of the drive unit enters an interior of the shell through the opening when in the folded state and/or unfolded state.

7. The electric television bracket according to claim 5, wherein there are a folded state and an unfolded state between the fix seat and the installation rack due to a change of their relative positions, and the connection mechanism is located within a range limited by the fix seat in a length direction when in the folded state and/or unfolded state.

8. The electric television bracket according to claim 6, wherein the drive unit is located within a space defined by a top of the fix seat and a bottom of the installation rack when in the folded state.

9. The electric television bracket according to claim 1, wherein the drive unit comprises a telescopic mechanism, the telescopic mechanism drives the installation rack through a change of a length of the telescopic mechanism to achieve an angle adjustment between the fix seat and the installation rack.

10. The electric television bracket according to claim 1, wherein the installation rack comprises a support rack and a hang plate provided on the support rack, and the hang plate is provided with one or more installation holes;
wherein, the installation rack further comprises a positioning unit comprising a stop part and a fastener, the stop part is slidably provided on the support rack and fixed by the fastener, the hang plate is limited by the stop part in a width direction of the support rack.

11. An electric television bracket, comprising:
a fix seat;
an installation rack, configured to install a television;
a connector, wherein one end thereof is fixed to the fix seat and the other end thereof is rotatably connected to the installation rack;
a connection mechanism, wherein one end thereof is rotatably connected to the installation rack and the other end thereof is rotatably connected to the fix seat; and
a drive unit, wherein a first end thereof is rotatably connected to the connection mechanism and a second end thereof is rotatably connected to the fix seat; wherein an angle adjustment between the fix seat and the installation rack is achieved through an action of the connection mechanism;
wherein, the connection mechanism further comprises a pivot, and a first end of the drive unit is rotatably connected to the pivot;
wherein, the connection mechanism comprises a first connection rod and a second connection rod, a first end of the first connection rod is rotatably connected to the fix seat, a first end of the second connection rod is rotatably connected to the installation rack, and a second end of the first connection rod and a second end of the second connection rod are respectively rotatably connected to the pivot.

12. The electric television bracket according to claim 11, wherein the fix seat comprises a flat base and a shell provided on the base, wherein the shell has an opening communicating an internal space of the shell.

13. The electric television bracket according to claim 12, wherein there are a folded state and an unfolded state between the fix seat and the installation rack due to a change of their relative positions; and at least a part of the drive unit enters an interior of the shell through the opening when in folded state and/or the unfolded state.

14. The electric television bracket according to claim 13, wherein the drive unit is located within a space defined by a top of the fix seat and a bottom of the installation rack when in the folded state.

15. The electric television bracket according to claim 11, wherein the drive unit comprises a telescopic mechanism, the telescopic mechanism drives the connection mechanism through a change of a length of the telescopic mechanism to achieve an angle adjustment between the fix seat and the installation rack.

16. The electric television bracket according to claim 12, wherein the shell further comprises a fix box placing a power supply of the drive unit.

17. The electric television bracket according to claim 16, wherein at least 80% of an area of the fix box is within a range defined by the shell in a projection direction of a width direction of the shell.

18. The electric television bracket according to claim 11, wherein the installation rack comprises a support rack and a hang plate provided on the support rack, and the hang plate is provided with one or more installation holes;
the installation rack further comprises a positioning unit comprising a stop part and a fastener, the stop part is slidably installed on the support rack and fixed by the fastener, the hang plate is limited by the stop part in a width direction of the support rack.
